(19) United States
(12) Patent Application Publication
(10) Pub. No.: US 2007/0115507 A1
(43) Pub. Date: May 24, 2007

(54) Method and apparatus for compensating for malfunctioning nozzle of inkjet image forming apparatus

(75) Inventors: Terekhov Vladislav, Suwon-si (KR); Ki-min Kang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/520,676

(22) Filed: Sep. 14, 2006

(30) Foreign Application Priority Data
Nov. 23, 2005 (KR) 2005-112198

(51) Int. Cl. H04N 1/405

(52) U.S. Cl. 358/3.13; 358/3.26

(57) ABSTRACT

Provided are a method and apparatus for compensating for the degradation of a print image due to a malfunctioning nozzle that irregularly ejects ink. The method includes detecting a malfunctioning nozzle among nozzles installed in an inkjet image forming apparatus and increasing a dithering threshold of an adjacent position to a compensation position printed by the detected malfunctioning nozzle. The method adjusts a dithering threshold of a print position of the malfunctioning nozzle or a dithering threshold of an adjacent print position, and thus performs a halftoning transaction and prints an image. Accordingly, the degradation of print quality such as a visible white band can be prevented and the lifetime of the printhead can be lengthened.

### CROSS-REFERENCE TO RELATED PATENT APPLICATIONS

This application claims the benefit under 35 U.S.C. §119(a) of Korean Patent Application No. 10-2005-0112198, filed on Nov. 23, 2005, in the Korean Intellectual Property Office, the entire disclosure of which is hereby incorporated by reference.

### BACKGROUND OF THE INVENTION

1. Field of the Invention

The present invention relates to an inkjet image forming apparatus. More particularly, the present invention relates to a method and apparatus for an inkjet image forming apparatus which can compensate for image degradation caused by malfunctioning nozzles and a method of compensating for malfunctioning nozzles of the an inkjet image forming apparatus.

2. Description of the Related Art

An inkjet image forming apparatus forms images by ejecting ink from a printhead. The printhead is placed a predetermined distance apart from a print medium and reciprocally moves in a direction perpendicular to a transferring direction of the print medium. Such an inkjet image forming apparatus is referred to as a shuttle type inkjet image forming apparatus. A nozzle unit having a plurality of nozzles for ejecting ink is installed in a printhead of the shuttle-type inkjet image forming apparatus.

Recently, a printhead having a nozzle unit with a length corresponding to the width of a print medium has been used to obtain high-speed printing. An image forming apparatus operated in this manner is referred to as a line printing type inkjet image forming apparatus. In the line printing type inkjet image forming apparatus, a printhead is fixed and only a print medium is transferred. Accordingly, a driving device of an inkjet image forming apparatus is simple and high-speed printing can be performed.

FIG. 1 shows printing patterns obtained when a nozzle of a conventional inkjet image forming apparatus malfunctions. FIGS. 2A through 2D are pixel images for explaining a method of compensating for a malfunctioning nozzle of the conventional inkjet image forming apparatus.

Referring to FIG. 1, the inkjet image forming apparatus forms an image by ejecting ink 1 from nozzles 82 formed in a nozzle unit 80 onto a print medium. When a nozzle 84 malfunctions, the malfunctioning nozzle 84 irregularly ejects ink 1 so that a missing line appears on the print medium, as illustrated in FIG. 1. That is, when a malfunctioning nozzle 84 exists among a plurality of nozzles 82, a missing line such as a visible white line will appear on the print medium because the malfunctioning nozzle irregularly ejects ink. Thus, the printing quality is degraded by the presence of the missing line.

A method of compensating for the image quality degradation due to a malfunctioning nozzle is disclosed in U.S. Pat. No. 5,581,284 which is hereby incorporated herein by reference. FIGS. 2A through 2D are the same drawings illustrated in FIGS. 3 through 6 of U.S. Pat. No. 5,581,284.

The above U.S. Patent discloses a method of compensating for a malfunctioning nozzle in an inkjet image forming apparatus. The malfunctioning nozzle may be a bad or non-droplet ejecting nozzle. When a malfunctioning nozzle 63 for ejecting black ink is identified, ink droplets of other colors, for example, cyan, magenta, and yellow, are sequentially ejected to a region to which the malfunctioning nozzle should have ejected black ink. These processes are illustrated in FIGS. 2B, 2C, and 2D. As described above, the black color can be represented by printing the cyan, magenta, and yellow ink droplets on the same location of the print medium, and the represented black is called process black or composite black. However, while this method is useful to compensate for malfunction of a nozzle ejecting black ink, it is not useful to compensate for malfunction of nozzles ejecting other colors. Further, when one of the nozzles used for compensation malfunctions, other colors such as red (yellow+magenta), green (cyan+yellow), or blue (cyan+magenta) color are printed in place of black, and thus printing quality is deteriorated.

Hence, there is a need for an improved method and apparatus of compensating for malfunctioning nozzles to improve the image quality.

### SUMMARY OF THE INVENTION

Exemplary embodiments of the present invention address at least the above problems and/or disadvantages and provide at least the advantages described below. Accordingly, an aspect of the present invention provides a method and apparatus for compensating for a malfunctioning nozzle that can effectively compensate for image degradation caused by malfunctioning nozzles in order to enhance printing quality.

According to an exemplary aspect of the present invention, there is provided a method of compensating for a malfunctioning nozzle in an inkjet image forming apparatus including detecting a malfunctioning nozzle among nozzles installed in the inkjet image forming apparatus and increasing a dithering threshold of an adjacent position to a compensation position printed by the detected malfunctioning nozzle.

In the increasing of the dithering threshold, the dithering threshold of the compensation position may be changed with the dithering threshold of the adjacent print position.

The increasing of the dithering threshold may include selecting a normal operating nozzle among nozzles adjacent to the malfunctioning nozzle and increasing a dithering threshold of a print position printed by the selected normal operating nozzle and adjacent to the compensation position.

According to another exemplary aspect of the present invention, there is provided a method of compensating for a malfunctioning nozzle in an inkjet image forming apparatus including increasing a first color dithering threshold of an adjacent position to a compensation position printed by the detected malfunctioning nozzle and increasing a second color dithering threshold of the compensation position.

The first color may be printed by the malfunctioning nozzle and the second color may be different from the first color.

In the increasing of the second color dithering threshold, when a second color dithering threshold of an adjacent print position to the compensation position is greater than a second color dithering threshold of the compensation position, the second color dithering threshold of the compensation position may be changed with the second color dithering threshold of the adjacent print position.

According to another exemplary aspect of the present invention, there is provided a malfunctioning nozzle compensating apparatus in an inkjet image forming apparatus, the apparatus including a malfunctioning nozzle detecting unit detecting a malfunctioning nozzle among nozzle installed in the inkjet image forming apparatus and a threshold adjusting unit increasing a dithering threshold of an adjacent position to a compensation position printed by the detected malfunctioning nozzle.

The threshold adjusting unit may change the dithering threshold of the compensation position with the dithering threshold of the adjacent print position.

The apparatus may further include a threshold comparing unit comparing a second color dithering threshold of the compensation position with a second color dithering threshold of the adjacent print position, wherein when the second color dithering threshold of the adjacent print position is greater than the second color dithering threshold of the compensation position, the second color dithering threshold of the adjacent print position is changed with the second color dithering threshold of the compensation position, wherein the second color is printed by a normal operating nozzle disposed at the same position as the malfunctioning nozzle.

The exemplary method of compensating for a malfunctioning nozzle may be embodied as computer programs recorded on a computer readable recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 shows printing patterns when a nozzle unit of a conventional line printing type inkjet image forming apparatus malfunctions;

FIGS. 2A through 2D are pixel images for explaining a method of compensating for a malfunctioning nozzle unit of the conventional inkjet image forming apparatus;

FIG. 3 is a schematic cross-sectional view of an inkjet image forming apparatus according to an exemplary embodiment of the present invention;

FIG. 4 illustrates a structure of a nozzle driving unit that drives a plurality of nozzles in a printhead according to an exemplary embodiment of the present invention;

FIG. 5 is a block diagram illustrating a malfunctioning nozzle compensating apparatus in an inkjet image forming apparatus, according to an exemplary embodiment of the present invention;

FIG. 6 illustrates dithering thresholds mapped on a compensation position, which is a print position of a malfunctioning nozzle, and adjacent print positions, according to an exemplary embodiment of the present invention;

FIG. 7 illustrates dithering thresholds when a threshold adjusting unit of FIG. 5 increases a dithering threshold of an adjacent print position, according to an exemplary embodiment of the present invention;

FIG. 8 illustrates dithering thresholds when the threshold adjusting unit of FIG. 5 changes a dithering threshold of an compensation position for a dithering threshold of an adjacent print position, according to another exemplary embodiment of the present invention;

FIG. 9 is a block diagram illustrating a configuration of the threshold adjusting unit of FIG. 5 according to an exemplary embodiment of the present invention;

FIGS. 10A through 10C illustrate a method of adjusting dithering thresholds of two colors by the threshold adjusting unit of FIG. 9, according to an exemplary embodiment of the present invention;

FIG. 11 is a flow chart of a method of compensating for a malfunctioning nozzles according to an exemplary embodiment of the present invention; and

FIG. 12 is a flow chart of a method of compensating for a malfunctioning nozzle according to another exemplary embodiment of the present invention.

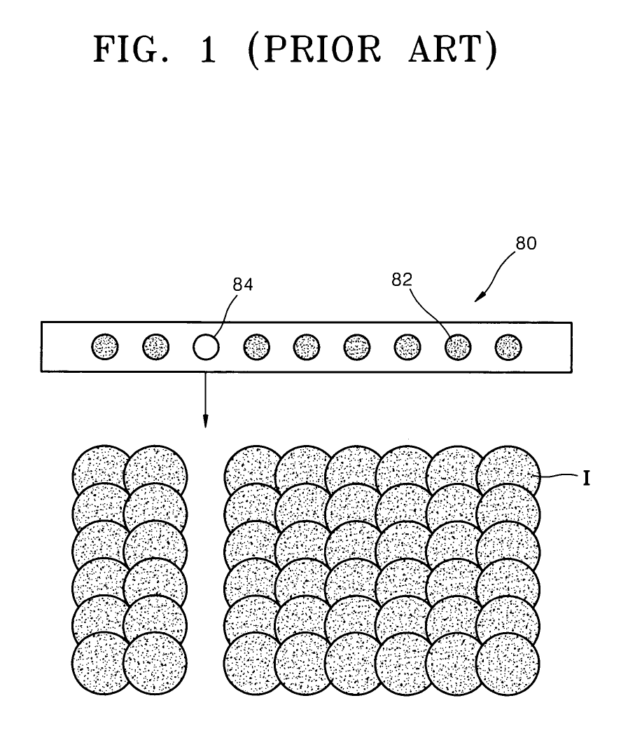

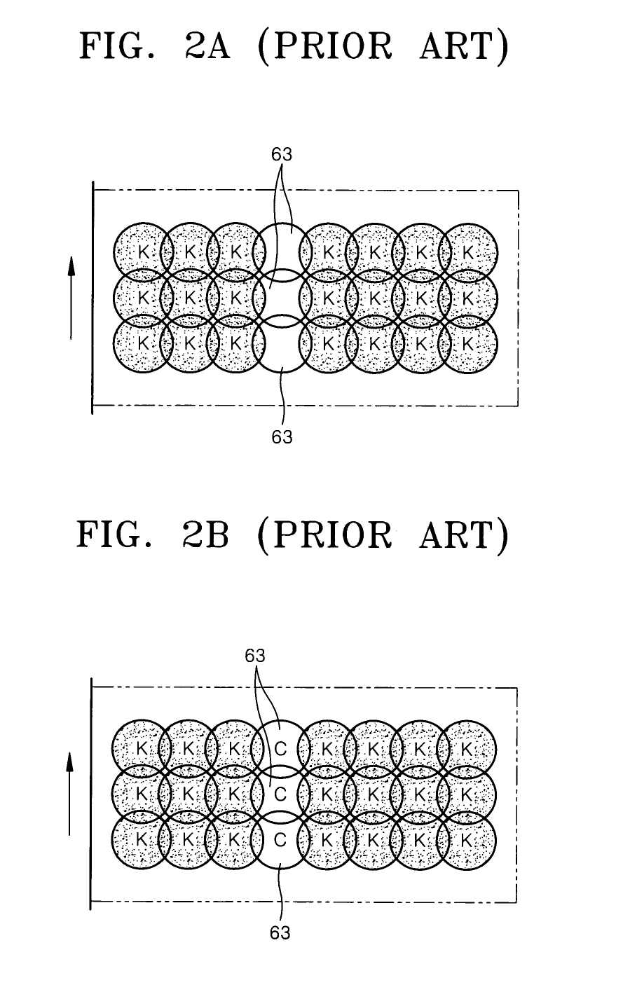

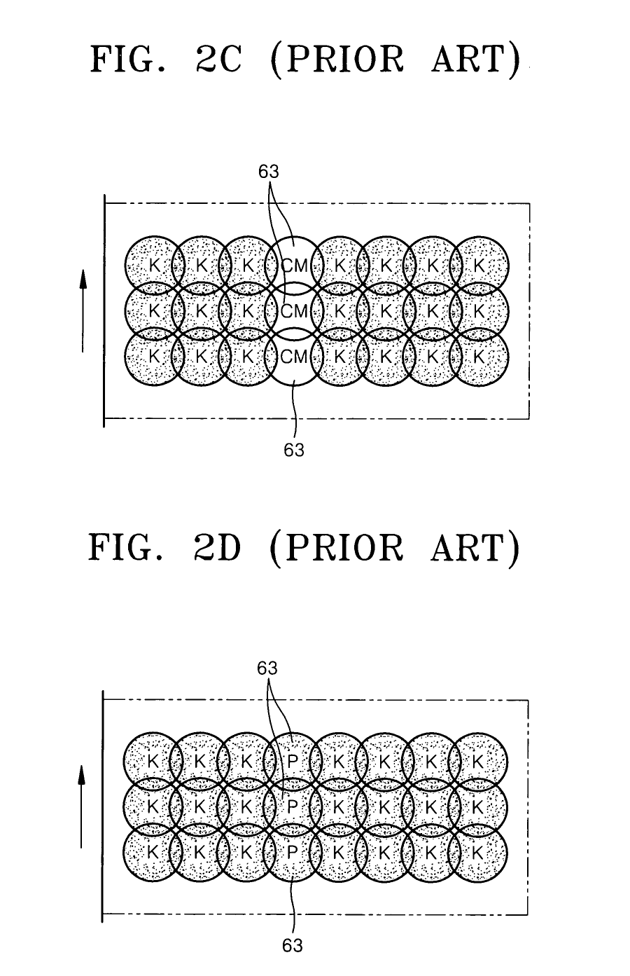

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary method and apparatus for compensating for a malfunctioning nozzle and an inkjet image forming apparatus using the same will now be described more fully with reference to the accompanying drawings, in which exemplary embodiments of the invention are shown. For convenience of explanation, the entire exemplary structure of the inkjet image forming apparatus and a half-toning transaction using dithering will be described first, and then the exemplary method and apparatus for compensating for the malfunctioning nozzle will be described. In the drawings, the thicknesses of lines and sizes are exaggerated for clarity and convenience. Also, the terms used herein are defined according to the functions of the present invention. Thus, the terms may vary depending on users or operators and usages. That is, the terms used herein must be understood based on the descriptions made herein.

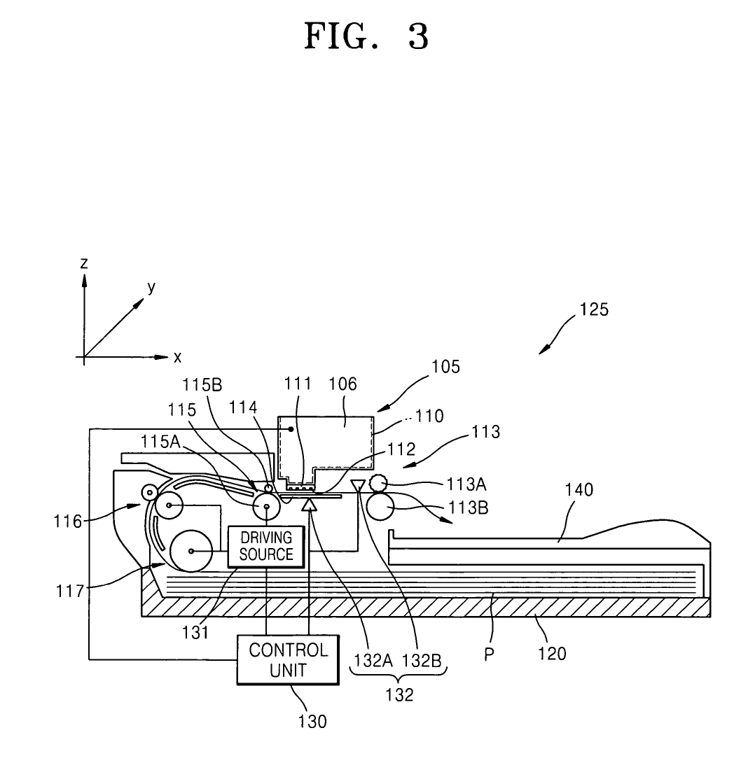

FIG. 3 is a schematic cross-sectional view of an inkjet image forming apparatus according to an exemplary embodiment of the present invention.

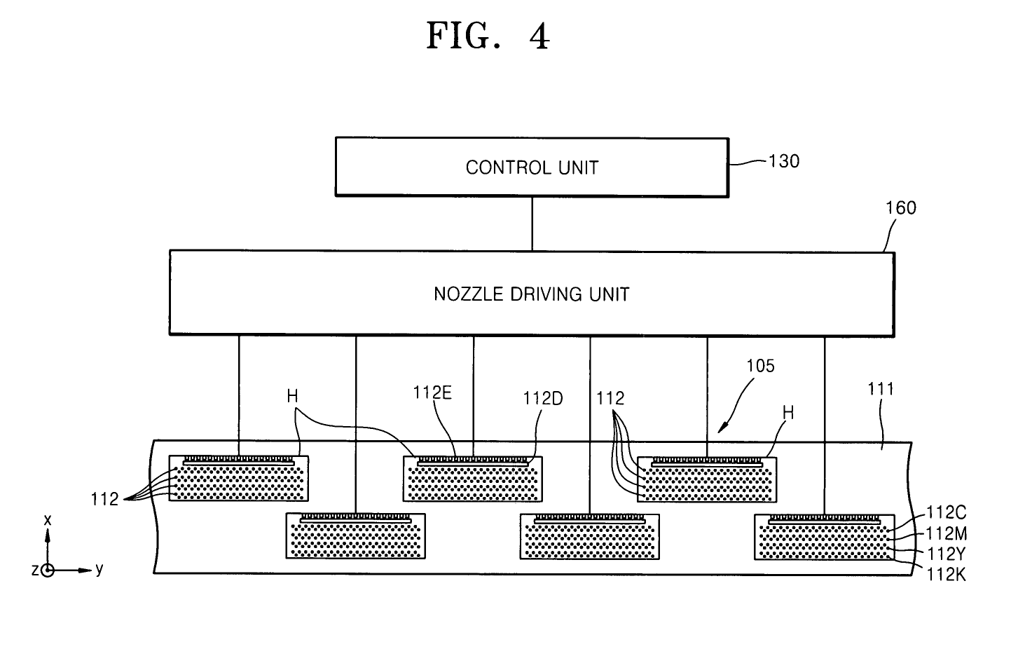

Referring to FIG. 3, the inkjet image forming apparatus 125 includes a feeding cassette 120, a printhead unit 105, a supporting member 114 opposite to the printhead unit 105, a malfunctioning nozzle detecting unit 132 detecting the generation and position of a malfunctioning nozzle, a print medium transferring unit transferring a print medium P in a first direction, in other words, an x direction, and a stacking unit 140 on which the discharged print medium P is stacked. In addition, the inkjet image forming apparatus 125 further includes a nozzle driving unit 160 (see FIG. 4) and a control unit 130 controlling each component thereof.

The print medium P is stacked on the feeding cassette 120. The print medium P is transferred from the feeding cassette 120 through a printhead 111 to the stacking unit 140 by the print medium transferring unit. The stacking unit 140 is, for example, a discharging paper tray, where the print medium P on which an image is formed is stacked after discharging.

The print medium transferring unit transfers the print medium P along a path, and includes a pick-up roller 117, an auxiliary roller 116, a feeding roller 115, and a discharging roller 113. The print medium transferring unit is driven by a driving source 131, such as a motor, and provides a transferring force to transfer the print medium P. The driving source 131 is controlled by the control unit 130.

The pick-up roller 117 is installed on one side of the feeding cassette 120 and picks up the print medium P stacked in the feeding cassette 120. The feeding roller 115 is installed at an inlet side of the printhead 111 and feeds the print medium P drawn out by the pick-up roller 117 to the printhead 111. The feeding roller 115 includes a driving roller 115A to supply a transferring force to transfer the print medium P, and an idle roller 115B elastically engaged with the driving roller 115A. The auxiliary roller 116 that transfers the print medium P may be further installed between the pick-up roller 117 and the feeding roller 115. The discharging roller 113 is installed at an outlet side of the printhead 111 and discharges the print medium P on which the printing has been completed, to an outside of the image forming apparatus 125. The discharging roller 113 includes a star wheel 113A installed in a width direction of the print medium P, and a supporting roller 113B which is opposite to the star wheel 113A and supports a rear side of the print medium P. The star wheel 113A may prevent the print medium P, fed in a downward direction of a nozzle unit 112, from contacting the bottom surface of the nozzle unit 112 or a body 110, and may prevent the distance between the print medium P and the bottom surface of the nozzle unit 112 or the body 110 from being changed. The star wheel 113A is installed such that at least a portion of the star wheel 113A protrudes below the nozzle unit 112, and contacts at a point of a top surface of the print medium P. The discharged print medium P is stacked on the stacking unit 140.

The supporting member 114 is installed below the printhead 111 and supports the rear side of the print medium P to maintain a distance between the nozzle unit 112 and the print medium P. The distance between the nozzle unit 112 and the print medium P may be about 0.5-2.5 mm.

The malfunctioning nozzle detecting unit 132 detects a malfunctioning nozzle generated in a manufacturing process or occurring during printing. In addition, the malfunctioning nozzle detecting unit 132 inspects ejecting operations of adjacent nozzles to the malfunctioning nozzle. That is, the malfunctioning nozzle detecting unit 132 inspects each nozzle in the nozzle unit 112, and a memory (not illustrated) stores the information about the ejecting operations of the nozzle. The malfunctioning nozzle indicates a bad or non-droplet ejecting nozzle. The malfunctioning nozzle may exist when ink is not ejected from a nozzle due to one or several causes or when a smaller amount of ink droplets is ejected.

The malfunctioning nozzle may be generated in a process of manufacturing the printhead 111 or may occur during printing. In general, the information of the malfunctioning nozzle generated in the manufacturing process is stored in a memory (not illustrated) installed in the printhead 111 and may be transmitted to the image forming apparatus 125 when the printhead is mounted in the image forming apparatus 125.

In general, printheads of inkjet image forming apparatuses are classified into two types according to an actuator that provides an ejecting force to ink droplets. The first type is a thermal driving printhead that generates bubbles in ink using a heater, thereby ejecting ink droplets due to an expanding force of the bubbles. The second type is a piezoelectric driving printhead that ejects ink droplets using a pressure applied to ink due to deformation of a piezoelectric device. When ink is ejected using thermal driving, defects of nozzles generated when a heater used for ejecting ink is disconnected or a driving circuit of the heater is broken, or malfunctions of nozzles occurred by damages of an electrical element such as a field effect transistor FET, and the like can be easily detected. Likewise, when ink is ejected using piezoelectric driving, defects of a piezoelectric device or malfunctions of nozzles occurred by damages of a driving circuit for driving the piezoelectric device can be easily detected.

However, the causes of a malfunctioning nozzle may not be easily detected when the nozzle is clogged with foreign objects. When the causes of a malfunctioning nozzle cannot be easily detected, test page printing is performed. If a malfunctioning nozzle exists in the nozzle unit 112, due to missing dots, the print concentration on a portion of a print medium P printed by the malfunctioning nozzle is lower than on a portion of the print medium P printed by a normal nozzle. Accordingly, the generation and position of a malfunctioning nozzle can be detected using the concentration difference.

The malfunctioning nozzle detecting unit 132 includes a first detecting unit 132A and a second detecting unit 132B. In an exemplary embodiment, the first detecting unit 132A detects whether or not nozzles are clogged by radiating light directly onto the nozzle unit 112, and the second detecting unit 132B detects whether or not a malfunctioning nozzle exists in the nozzle unit 112 by radiating light onto the print medium P when the print medium P is transferred. The malfunctioning nozzle detecting unit 132 includes an optical sensor. The optical sensor includes a light-emitting sensor such as a light emitting diode that radiates light onto the nozzle unit 112 or the print medium P and a light-receiving sensor that receives light reflected from the nozzle unit 112 or the print medium P. An output signal from the light-receiving sensor is input to the second detecting unit 132B. The malfunctioning nozzle detecting unit 132 detects whether or not a malfunctioning nozzle exists in the nozzle unit 112 in response to the output signal transmitted from the light-receiving sensor, and information about whether or not the malfunctioning nozzle exists in the nozzle unit 112 is transmitted to the control unit 130. The light emitting sensor and the light receiving sensor can be formed as an integrated type or several separate units. The structures and functions of the optical sensor are well known to those of ordinary skill in the art, and thus a detailed description thereof will be omitted.

Although not illustrated, the malfunctioning nozzle detecting unit 132 respectively transmits nozzle inspection signals to the nozzle and detects the occurrence and position of a malfunctioning nozzle in response to the transmitted nozzle inspection signals, according to an exemplary embodiment of the present invention.

The method of detecting a malfunctioning nozzle is well-known to those of ordinary skill in the art, and thus a detailed description thereof will be omitted. Otherwise, various apparatuses and methods known to those of ordinary skill in the art can be employed for detecting whether or not a malfunctioning nozzle exists.

The malfunctioning nozzle detecting unit 132 detects the generation and position of the malfunctioning nozzle in the nozzle unit 112 using the above-described series of processes. Information of the malfunctioning nozzle detected by the malfunctioning nozzle detecting unit 132 is stored in a memory (not illustrated). The control unit 130 controls the operation of each component of the image forming apparatus 125 to compensate for the malfunctioning nozzle according to the information of the malfunctioning nozzle stored in the memory (not illustrated). The information of the malfunctioning nozzle includes the position of a malfunctioning nozzle or an ink color ejected from the malfunctioning nozzle.

The printhead unit 105 prints an image by ejecting ink onto the print medium P, and includes the body 110, the printhead 111 installed on one side of the body 110, the nozzle unit 112 formed on the printhead 111, and a carriage 106 where the body 110 is mounted. The body 110 may be mounted into the carriage 106 in a cartridge type manner. The feeding roller 115 is rotatably installed at an inlet side of the nozzle unit 112, and the discharging roller 113 is rotatably installed at an outlet side of the nozzle unit 112.

Although not illustrated, an ink container storing ink is provided in the body 110. Further, the body 110 may include chambers, each of which has a nozzle driving unit (for example, piezoelectric elements or heat-driving typed heaters), that are connected to respective nozzles of the nozzle units 112 and provide pressure to eject the ink, a passage (for example, an orifice) for supplying the ink contained in the body 110 to each chamber, a manifold that is a common passage for supplying the ink flowed through the passage to the chamber, and a restrictor that is an individual passage for supplying the ink from the manifold to each chamber. The chamber, the ejecting unit, the passage, the manifold, and the restrictor are well-known to a person skilled in the art, and thus detailed descriptions thereof will be omitted. In addition, the ink container (not illustrated) may be separately installed from the printhead unit 105. The ink stored in the ink container (not illustrated) may be supplied to the printhead unit 105 through a supplying unit such as a hose.

FIG. 4 illustrates a structure of a nozzle driving unit that drives a plurality of nozzles in a printhead, according to an exemplary embodiment of the present invention. Referring to FIG. 4, a method of driving the printhead will be described.

The nozzle driving unit 160 provides an ejecting force to ink droplets, and drives the printhead 111 with a frequency to print an image on the print medium P. Nozzle driving units 160 are classified into two types according to an actuator that provides an ejecting force to ink droplets. The first type is a thermal driving printhead that ejects ink droplets using a heater. The second type is a piezoelectric driving printhead that ejects ink droplets using a piezoelectric device. The nozzle driving unit 160 driving the nozzles in the nozzle unit 112 is controlled by the control unit 130.

In general, the printheads 111 are classified into two types: a shuttle type and a line printing type. A shuttle type inkjet image forming apparatus prints an image using the printhead 111 which reciprocally moves in a direction perpendicular to a transferring direction of the print medium P. A line printing type inkjet image forming apparatus having a printhead 111 with a length corresponding to the width of a print medium P. The present invention can be applied to a shuttle type inkjet image forming apparatus or a line printing type inkjet image forming apparatus as well as to apparatuses employing other types of printheads. As an exemplary embodiment, a printhead in a line printing type inkjet image forming apparatus will be described.

The printhead 111 is installed along a second direction, in other words, the y direction, with respect to the print medium P which transfers along a first direction, in other words, the x direction. The printhead 111 uses heat energy or a piezoelectric device as an ink ejecting source, and is made to have a high resolution. The printhead may be fabricated using a semiconductor manufacturing process such as etching, deposition, sputtering and the like. The printhead unit 111 includes a nozzle unit 112 which prints an image by ejecting ink onto the print medium P.

The nozzle unit 112 may have a length equal to or longer than a width of the print medium P. Referring to FIG. 4, a plurality of head chips H having a plurality of nozzle row arrays 112C, 112M, 112Y, and 112K may be formed in the printhead 111. The reference numeral 112C denotes a cyan nozzle array, the reference numeral 112M denotes a magenta nozzle array, the reference numeral 112Y denotes a yellow nozzle array, and the reference numeral 112K denotes a black nozzle array. Each of the head chips H may be formed of one chip having a length equal to that of the printhead 111, in other words, a width of the print medium P.

In an exemplary embodiment, a line printing type printhead 111 including a nozzle unit 112 having a plurality of head chips H is described, but the present invention can be applied to variously formed printheads. For example, an inkjet image forming apparatus may include a shuttle type printhead or other types of printheads. Therefore, the printhead 111 and the nozzle unit 112 illustrated in FIG. 4 do not limit the technical scope of the prevent invention.

Each of the nozzles in the nozzle unit 112 includes a driving circuit 112D and a cable 112E to receive printing data, electric power, control signals, and the like. The cable 112E may be a flexible printed circuit (FPC) or a flexible flat cable (FFC).

In the inkjet image forming apparatus 125, image data of each pixel is generally binarized using a halftoning transaction such that the control unit 130 generates a driving signal for determining respective ink ejection of the plurality of nozzles.

The halftoning transaction is used as an image processing method employed in an apparatus treating restricted tone values, and reduces a quantized tone per pixel, but prints an image similar to an original image. The halftoning transaction is used in image printing apparatuses such as cylinder printing presses, image forming apparatuses, or liquid crystal displays. For example, the halftoning transaction can convert 8-bit image data (0 through 255) to 1-bit binary data (0 or 1). A dithering method is one of the halftoning transactions.

Hereinafter, the dithering method will be described for the case where a continuous-tone image representing cyan (C), magenta (M), yellow (Y), and black (K) color image data, which have values between 0 to 255, is dithered to be binarized.

A dither matrix having a plurality of dithering thresholds is mapped on the continuous-tone image. The dither matrix may be a scroll matrix, a spiral matrix, a dotted matrix, a blue noise matrix, and the like. In addition, the size of the dither matrix may vary, for example, 4×4, 8×8, 16×16, or 32×32 pixel size. The dither matrixes for cyan (C), magenta (M), yellow (Y), and black (K) colors exist. All or some matrix may be identical or all matrixes may be different from each other.

When the size of a space, which the dither matrix occupies, is smaller than the size of an image to be printed, the dither matrix is reproduced to fit the size of the image such that the dithering can be performed regardless of the size of the image.

For each pixel in which the dither matrix is mapped, image data ranging from 0 to 255 is compared with a mapped dithering threshold. When the image data of a pixel is smaller than the dithering threshold, an ink dot is printed on the position of the pixel. When the image data of a pixel is greater than the dithering threshold, the image data is binarized to 0 or 1 in order not to print an ink dot on the position of the pixel. Accordingly, as the dithering threshold to be mapped increases, the possibility that the image date of the position is smaller than the dithering threshold is high, and thus the possibility that ink is ejected on the position is high.

When the dithering is performed with respect to cyan (C), magenta (M), yellow (Y), and black (K), data having information about the ejection of these four color inks is generated.

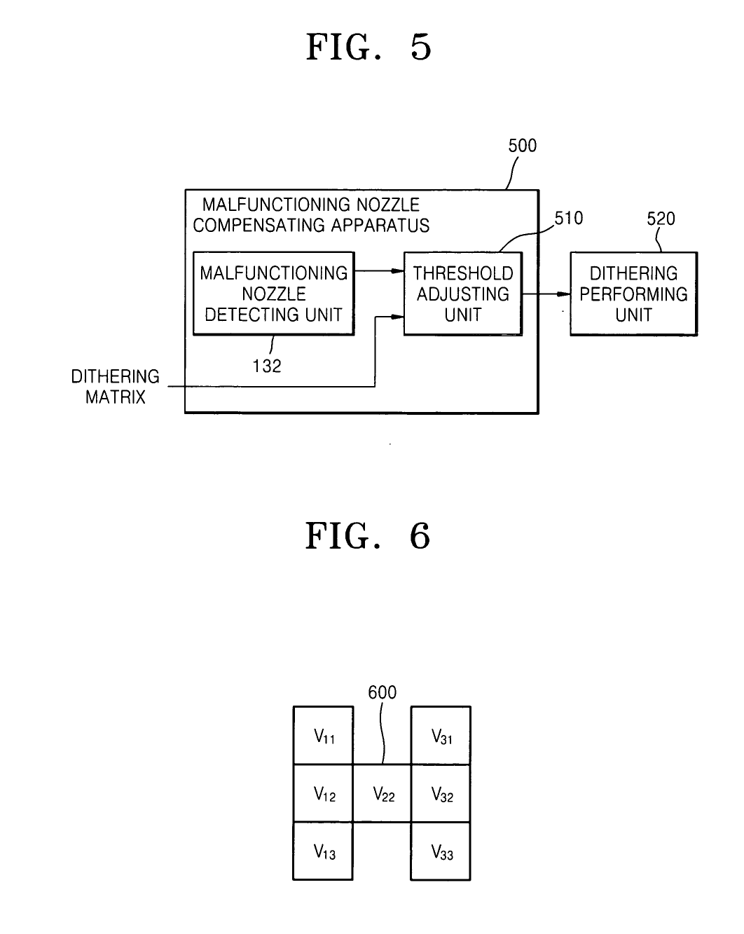

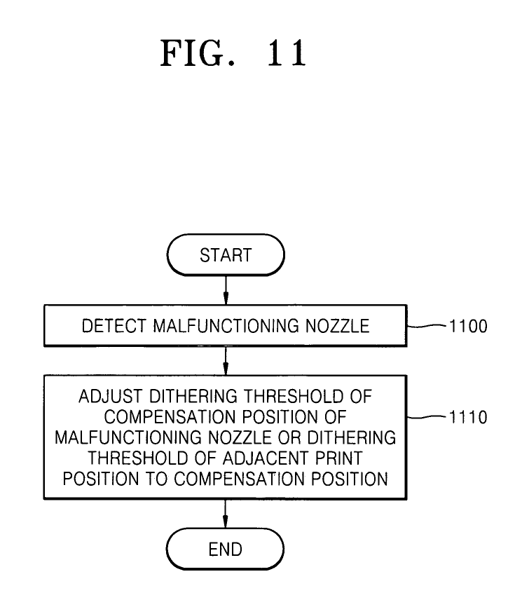

FIG. 5 is a block diagram illustrating a malfunctioning nozzle compensating apparatus 500 in an inkjet image forming apparatus, according to an exemplary embodiment of the present invention. The malfunctioning nozzle compensating apparatus 500 includes the malfunctioning nozzle detecting unit 132 and a threshold adjusting unit 510. The operation of the malfunctioning nozzle compensating apparatus 500 will be described in conjunction with a flowchart of a method of compensating for a manufacturing nozzle illustrated in FIG. 11.

The malfunctioning nozzle detecting unit 132 inspects ejection states of nozzles in the nozzle unit 112 installed in the image forming apparatus 125, detects a malfunctioning nozzle, and generates and outputs information of the detected malfunctioning nozzle in operation 1100. The methods of detecting a malfunctioning nozzle and generating information of the malfunctioning nozzle by the malfunctioning nozzle detecting unit 132 have been described with reference to FIG. 3, and thus will be omitted.

The threshold adjusting unit 510 receives the dither matrix having the information of the malfunctioning nozzle and the dithering thresholds to be mapped at the print position of an image to be printed. The threshold adjusting unit 510 adjusts a dithering threshold to be mapped at a compensation position or adjacent position to the compensation position in the dithering matrix in operation 1110. If the detected malfunctioning nozzle normally ejects ink, the malfunctioning nozzle ejects ink onto a position of a print medium P. The compensation position denotes this position. In operation 11110, as the dithering threshold increases, the possibility that ink is ejected onto the mapped print position becomes high, but as the dithering threshold decreases, the possibility that ink is ejected onto the mapped print position becomes low.

FIG. 6 illustrates dithering thresholds mapped on a compensation position 600, which is a print position of a malfunctioning nozzle, and adjacent print positions, according to an exemplary embodiment of the present invention. Referring to FIG. 6, adjacent print positions above and below the compensation position 600 are positions that are also printed by the malfunctioning nozzle, and thus the adjacent print position may be selected from the other six adjacent positions for adjusting the dithering threshold, according to an exemplary embodiment of the present invention.

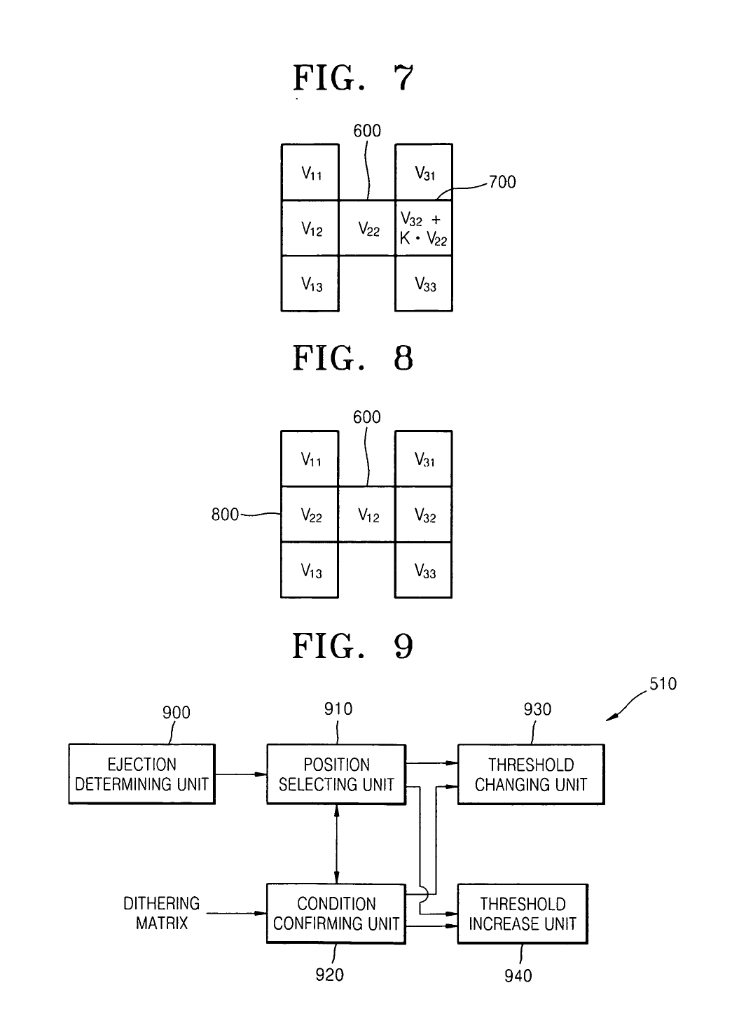

FIG. 7 illustrates dithering thresholds when the threshold adjusting unit 510 increases a dithering threshold of print position 700 adjacent to the compensation position 600. Referring to FIG. 7, the threshold adjusting unit 510 increases the dithering threshold of the adjacent print position 700 to adjust the dithering threshold. As described above, the threshold adjusting unit 510 increases the dithering threshold of the adjacent print position 700 from V32 to V32 +k V22, so that the possibility that ink is ejected to print an ink dot on the adjacent print position 700 increases. Accordingly, although an ink dot is not printed on the compensation position 600 due to the malfunctioning nozzle, an ink dot is printed on the adjacent print position 700, thereby reducing the degradation of print quality.

Threshold adjusting unit 510 increases the dithering threshold of the adjacent print position 700 using equation 1.
V′adjacent=Vadjacent+(k×Vdefect) (1)

where Vadjacent is a dithering threshold of the adjacent print position 700, Vdefect is a dithering threshold of the compensation position 600, V′adjacent is an increased dithering threshold of the adjacent print position 700, and k is a constant.

FIG. 8 illustrates dithering thresholds when the threshold adjusting unit 510 changes a dithering threshold of the compensation position 600 for a dithering threshold of an adjacent print position 800, according to another exemplary embodiment of the present invention. Referring to FIG. 8, the threshold adjusting unit 510 changes the dithering threshold of the compensation position 600 with a dithering threshold of the adjacent print position 800 to adjust the dithering threshold. When the dithering threshold of the compensation position 600 is greater than the dithering threshold of the adjacent print position 800, the threshold adjusting unit 510 changes the dithering threshold of the compensation position 600 for the dithering threshold of the adjacent print position 800, and thus the possibility that ink is ejected to print an ink dot on the adjacent print position 800 increases. Accordingly, the ink dot is printed on the adjacent print position 800, thereby preventing the degradation of print quality. This exemplary change method should be performed only when the dithering threshold of the compensation position 600 is greater than the dithering threshold of the adjacent print position 800. When the dithering threshold of the compensation position 600 is smaller than the dithering threshold of the adjacent print position 800, the dithering threshold of the adjacent print position 800 decreases, rather than increases, due to the change, and thus the possibility that ink is ejected to print an ink dot on the adjacent print position 800 decreases. When the dithering thresholds are changed, the dithering threshold of the compensation position 600 decreases from V22 to V12, and the dithering threshold of the adjacent print position 800 increases from V12 to V22, as illustrated in FIG. 8. Accordingly, the possibility ink is ejected to print an ink dot on the adjacent print position 800 increases, thereby compensating for the compensation position 600.

The adjacent print position of which the dithering thresholds are changed may be arbitrarily chosen from six adjacent print positions.

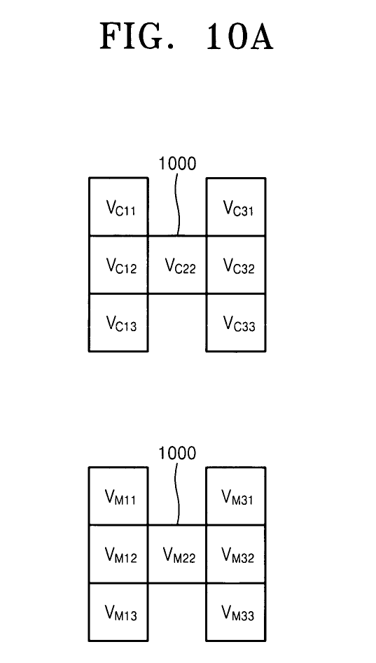

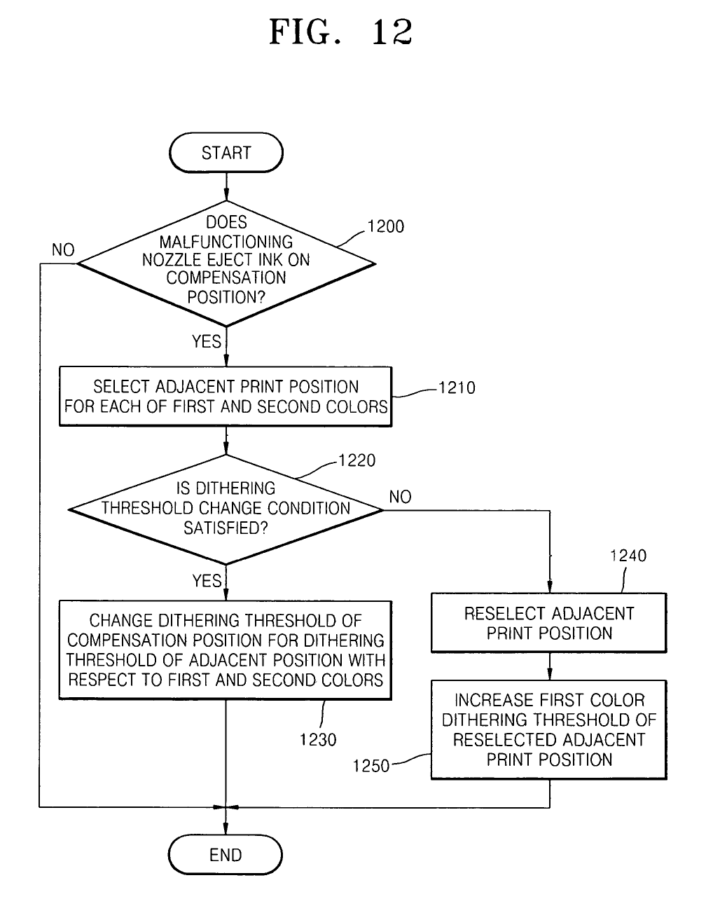

FIG. 9 is a block diagram illustrating a configuration of the threshold adjusting unit 510 according to an exemplary embodiment of the present invention. The threshold adjusting unit 510 includes an ejection determining unit 900, a position selecting unit 910, a condition confirming unit 920, a threshold changing unit 930, and a threshold increase unit 940. The operation of the threshold adjusting unit 510 will be described in conjunction with a flowchart of an exemplary method of compensating for a manufacturing nozzle illustrated in FIG. 12.

Hereinafter, a first color is a color printed on a print medium by a malfunctioning nozzle detected by malfunctioning nozzle detecting unit 132. For example, when four nozzles respectively print ink dots of four colors which is cyan (C), magenta (M), yellow (Y), and black (K) on a single print position, a color printed by a malfunctioning nozzle among four colors is the first color. The ejection determining unit 900 compares image data of the first color corresponding to a compensation position with a dithering threshold of the first color, and determines whether or not the malfunctioning nozzle prints an ink dot on the compensation position in operation 1200. As a result, when the malfunctioning nozzle has to print an ink dot on the compensation position, the malfunctioning nozzle is compensated for through the adjustment of the dithering threshold, as described below.

The position selecting unit 910 selects one of first color adjacent print positions to the compensation position for the first color and one of second color adjacent print positions to the compensation position for the second color in operation 1210. The position selecting unit 910 may arbitrarily select each of the first and second color adjacent print positions to the compensation position for the first and second color.

The condition confirming unit 920 confirms whether or not a first color dithering threshold of the compensation position is greater than a first color dithering threshold of the first color adjacent print position, and whether or not a second color dithering threshold of the compensation position is greater than a second color dithering threshold of the second color adjacent print position in operation 1220. As a result, when both conditions are satisfied, the first color dithering threshold of the compensation position is changed with the first color dithering threshold of the first color adjacent print position, and the second color dithering threshold of the compensation position is changed with the second color dithering threshold of the second color adjacent print position in operation 1230.

Because of the change of the first and second dithering thresholds, the possibilities that the first color, which cannot be normally printed on the compensation position due to the malfunctioning nozzle, is printed on the first color adjacent print position, and that the second color is printed on the compensation position increase. Therefore, the degradation of print quality due to the malfunctioning nozzle can be reduced.

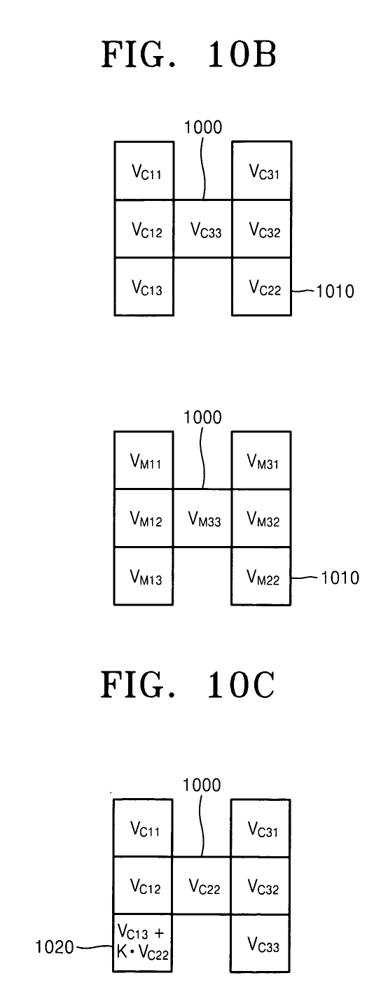

FIG. 10A illustrates dithering thresholds mapped on compensation positions and adjacent print positions for cyan (C) and magenta (M) colors. VC22 denotes a dithering threshold mapped on the compensation position 1000 for the cyan (C) color, and VM22 denotes a dithering threshold mapped on the compensation position 1000 for the magenta (M) color. In addition, the cyan (C) is a first color printed by a malfunctioning nozzle and the magenta (M) is a second color. FIG. 10B illustrates dithering thresholds when the threshold changing unit 930 changes dithering thresholds of FIG. 10A according to operation 1230 of FIG. 12. Referring to FIG. 10B, the threshold exchanging unit 930 changes a dithering threshold of the compensation position 1000 with a dithering threshold of an arbitrarily chosen adjacent print position 1010 of the cyan (C) color, and changes a dithering threshold of the compensation position 1000 with a dithering threshold of an arbitrarily chosen adjacent print position 1010 of the magenta (M) color.

As a result of the confirmation in operation 1220, when any one of the above-described two conditions is not satisfied, the position selecting unit 910 selects one of adjacent print positions to the compensation position 1000 in operation 1240. The threshold increase unit 940 increases a first color dithering threshold of the selected adjacent print position in operation 1250. The position selecting unit 910 may arbitrarily select one of the adjacent print positions. The threshold increase unit 940 may increase the first color dithering threshold of the selected adjacent print position using equation 1.

FIG. 10C illustrates dithering thresholds when the threshold increase unit 940 increases a first color dithering threshold of the cyan (C) color according to operation 1250. Referring to FIG. 10C, the threshold increase unit 940 changes a first dithering threshold of an arbitrarily chosen adjacent print position 1020 of the cyan (C) color with the dithering threshold of the compensation position 1000, and then increases the dithering threshold of the adjacent print position 1020 using equation 1.

The present invention can also be embodied as computer program codes stored in a computer readable recording medium. The computer readable recording medium is any data storage device that can store data which can be thereafter read by computer system. Examples of the computer readable recording medium include read-only memory (ROM), random-access memory (ROM), CD-ROMs, magnetic tapes, floppy disks, optical data storage devices, and carrier waves (such as data transmission through the internet).

As described above, the exemplary embodiments showing a method and apparatus for compensating for a malfunctioning nozzle in an inkjet image forming apparatus adjusts a dithering threshold of a print position of the malfunctioning nozzle and a dithering threshold of an adjacent print position, and thus performs a halftoning transaction and prints an image. Accordingly, the degradation of print quality such as a visible white band can be prevented and the lifetime of the printhead can be lengthened.

While the present invention has been particularly shown and described with reference to exemplary embodiments thereof, it will be understood by those of ordinary skill in the art that various changes in form and details may be made therein without departing from the spirit and scope of the present invention as defined by the following claims and the full scope of equivalents thereof.

What is claimed is:

1. A method of compensating for a malfunctioning nozzle in an inkjet image forming apparatus, the method comprising:
detecting a malfunctioning nozzle among nozzles installed in an inkjet image forming apparatus; and
increasing a dithering threshold of an adjacent print position to a compensation position of the detected malfunctioning nozzle.

2. The method of claim 1, wherein the increasing the dithering threshold comprises increasing the dithering threshold of the adjacent print position using the following equation:
V′adjacent=Vadjacent+(k×Vdefect)
where Vadjacent is a dithering threshold of the adjacent print position, Vdefect is a dithering threshold of the compensation position, V′adjacent is an increased dithering threshold of the adjacent print position, and k is a constant.

3. The method of claim 1, wherein, the increasing of the dithering threshold comprises changing the dithering threshold of the compensation position with the dithering threshold of the adjacent print position.

4. The method of claim 1, further comprising:
determining if the dithering threshold of the compensation position is smaller than the dithering threshold of the adjacent print position;
wherein the increasing the dithering threshold comprises increasing the dithering threshold of the adjacent print position using the following equation when the dithering threshold of the compensation position is determined to be smaller than the dithering threshold of the adjacent print position:
V′adjacent=Vadjacent+(k×Vdefect)
where Vadjacent is a dithering threshold of the adjacent print position, Vdefect is a dithering threshold of the compensation position, V′adjacent is an increased dithering threshold of the adjacent print position, and k is a constant, and
changing the dithering threshold of the compensation position for the dithering threshold of the adjacent print position when the dithering threshold of the compensation position is determined to be greater than the dithering threshold of the adjacent print position.

5. The method of claim 1, wherein the increasing of the dithering threshold comprises:
selecting a normal operating nozzle among nozzles adjacent to the malfunctioning nozzle; and
increasing a dithering threshold of a print position printed by the selected normal operating nozzle and adjacent to the compensation position.

6. A method of compensating for a malfunctioning nozzle in an inkjet image forming apparatus, the method comprising:
increasing a first color dithering threshold of an adjacent print position to a compensation position of a detected malfunctioning nozzle; and
increasing a second color dithering threshold of the compensation position.

7. The method of claim 6, wherein the first color is to be printed by the malfunctioning nozzle and the second color is different from the first color.

8. The method of claim 6, further comprising:
determining the first color dithering threshold of the compensation position;
wherein the increasing of the first color dithering threshold comprises increasing the first color dithering threshold of the adjacent print position using the following equation when the first color dithering threshold of the compensation position is determined to be smaller than the first color dithering threshold of the adjacent print position:
V′adjacent=Vadjacent+(k×Vdefect)
where Vadjacent is a first dithering threshold of the adjacent print position, Vdefect is a first dithering threshold of the compensation position, V′adjacent is an increased first dithering threshold of the adjacent print position, and k is a constant, and
wherein the first color dithering threshold of the compensation position is changed with the first color dithering threshold of the adjacent print position when the first color dithering threshold of the compensation position is determined to be greater than the first color dithering threshold of the adjacent print position.

9. The method of claim 6, further comprising:
determining a second color dithering threshold of an adjacent print position to the compensation position;
wherein the increasing of the second color dithering threshold comprises changing the second color dithering threshold of the compensation position with the second color dithering threshold of the adjacent print position when a second color dithering threshold of the adjacent print position to the compensation position is determined to be greater than a second color dithering threshold of the compensation position.

10. A malfunctioning nozzle compensating apparatus in an inkjet image forming apparatus, the compensating apparatus comprising:
a malfunctioning nozzle detecting unit for detecting a malfunctioning nozzle among nozzles installed in an inkjet image forming apparatus; and
a threshold adjusting unit for increasing a dithering threshold of an adjacent position to a compensation position of a detected malfunctioning nozzle.

11. The apparatus of claim 10, wherein the threshold adjusting unit increases the dithering threshold of the adjacent print position using the following equation:
V′adjacent=Vadjacent+(k×Vdefect)
where Vadjacent is a dithering threshold of the adjacent print position, Vdefect is a dithering threshold of the compensation position, V′adjacent is an increased dithering threshold of the adjacent print position, and k is a constant.

12. The apparatus of claim 10, wherein the threshold adjusting unit changes the dithering threshold of the compensation position with the dithering threshold of the adjacent print position.

13. The apparatus of claim 10, further comprising:
a threshold comparing unit for comparing a dithering threshold of the compensation position with the dithering threshold of the adjacent print position,
wherein when the dithering threshold of the compensation position is smaller than the dithering threshold of the adjacent print position, the threshold adjusting unit increases the dithering threshold of the adjacent print position using the following equation,
V′adjacent=Vadjacent+(k×Vdefect)
where Vadjacent is a dithering threshold of the adjacent print position, Vdefect is a dithering threshold of the compensation position, V′adjacent is an increased dithering threshold of the adjacent print position, and k is a constant, and
wherein when the dithering threshold of the compensation position is greater than the dithering threshold of the adjacent print position, the threshold adjusting unit changes the dithering threshold of the compensation position with the dithering threshold of the adjacent print position.

14. The apparatus of claim 10, further comprising:
a threshold comparing unit for comparing a second color dithering threshold of the compensation position with a second color dithering threshold of the adjacent print position,
wherein when the second color dithering threshold of the adjacent print position is greater than the second color dithering threshold of the compensation position, the second color dithering threshold of the adjacent print position is changed with the second color dithering threshold of the compensation position,
wherein the second color is printed by a normal operating nozzle disposed at the same position as the malfunctioning nozzle.

15. A computer-readable recording medium having recorded thereon instructions for implementing a method of compensating for a malfunctioning nozzle in an inkjet image forming apparatus, the medium comprising:
a first set of instructions for detecting a malfunctioning nozzle among nozzles installed in an inkjet image forming apparatus; and
a second set of instructions for increasing a dithering threshold of an adjacent print position to a compensation position of the detected malfunctioning nozzle.

16. A computer-readable recording medium having recorded instructions for implementing a method of compensating for a malfunctioning nozzle in an inkjet image forming apparatus, the medium comprising:
a first set of instructions for increasing a first color dithering threshold of an adjacent print position to a compensation position of a detected malfunctioning nozzle; and
a second set of instructions for increasing a second color dithering threshold of the compensation position.

17. A method of compensating for a malfunctioning nozzle in an inkjet image forming apparatus, the method comprising:
detecting a malfunctioning nozzle among nozzles installed in an inkjet image forming apparatus;
determining a compensation print position associated with the malfunctioning nozzle;
determining a print position adjacent to the compensation print position; and
increasing a dithering threshold of the adjacent print position.

18. A method of compensating for a malfunctioning nozzle in an inkjet image forming apparatus, the method comprising:
detecting a malfunctioning nozzle among nozzles installed in an inkjet image forming apparatus;
determining a compensation print position associated with the malfunctioning nozzle;
determining a print position adjacent to the compensation print position;
increasing a first color dithering threshold of the adjacent print position; and
increasing a second color dithering threshold of the compensation print position.
